(19) United States
(12) Patent Application Publication
(10) Pub. No.: US 2018/0116213 A1
(43) Pub. Date: May 3, 2018

(54) SYNERGISTIC COMPOSITION CONTAINING HERBICIDE, ORGANIC ACID AND SURFACTANT

(71) Applicant: MULTIBIND BIOTEC GMBH, KOELN (DE)

(72) Inventors: Thomas Lisowsky, Monheim (DE); Karlheinz Esser, Moenchengladbach (DE)

(21) Appl. No.: 15/572,511

(22) PCT Filed: May 11, 2016
(86) PCT No.: PCT/EP2016/060514

§ 371 Date: Nov. 8, 2017

(30) Foreign Application Priority Data
May 13, 2015 (EP) 15167621.0

(51) Int. Cl. A01N 25/30; A01N 57/12; A01N 37/38

(52) U.S. Cl. CPC A01N 25/30; A01N 37/38; A01N 57/12

(57) ABSTRACT

The present invention relates to new, highly efficient synergistic compositions comprising mixtures of organic acids in combination with specific detergents or emulgators. That is, applied as an adjuvant or additive, said mixtures significantly increase the efficacy and biocompatibility of conventional herbicide products. The new synergistic composition thereby allows significant reduction of active ingredients of conventional herbicide agents. The higher efficacy of the synergistic mixture also allows to address the elimination of herbicide-resistant or herbicide-tolerant plants.

### BACKGROUND

The present invention relates to a herbicide composition comprising at least one herbicide active ingredient and a mixture for enhancing at least one activity of the herbicide agent.

### PRIOR ART

Contaminations by weed or unwanted plants in agricultural production cause severe problems and commercial losses [1-4]. In general agricultural production world-wide is under permanent pressure for higher yield. Therefore the use of herbicides is essential to secure yield and quality of agricultural products and to reduce economic losses. The constantly growing world population puts additional pressure on yield and quality of agricultural products as well as on the generation and synthesis of new herbicide agents. A major concern is also the biocompatibility of such herbicide agents and their impact on human health and the environment [3]. In addition existing classical herbicide agents are reduced or even completely blocked in their efficacy by the appearance of resistances or tolerance developed by adaptations of weeds and unwanted plants under the constant exposure to high amounts of herbicides [1-4].

Besides the synthesis and generation of completely new herbicide agents the enhancement of the efficacy of established herbicide products by suitable additives or adjuvant are fitting alternatives.

Conventional herbicide agents used in well-established herbicide products with a broad spectrum against weed and other unwanted plants are for example glyphosate (N-(phosphonomethyl)glycine) and 2,4-dichlorophenoxyacetic acid (2,4-D).

The listed conventional herbicide products are among the major herbicide products used world-wide against weed and other unwanted plants. The large quantities and the long time of usage of such conventional products bear environmental risks, human health risks as well as risks concerning the development of tolerance and resistance [1-4]. Therefore the search for synergistic substances that increase the efficacy of conventional herbicide agents and thereby allow the reduction of active ingredients and increase the biocompatibility is a major demand and still unsolved problem of current agriculture [3]. A higher efficacy would allow the substantial reduction of the amount of conventional herbicide agents necessary as active ingredients per hectare and the elimination of herbicide tolerant or resistant plants.

### SUMMARY OF THE INVENTION

It is the object of the invention to overcome the current limitations and disadvantages of the prior art, to provide mixtures that significantly increase the efficacy and biocompatibility of conventional herbicide agents, and to develop herbicide compositions with reduced amount of herbicide agents that in addition also allow the elimination of already herbicide tolerant or resistant plants.

The object is met by a herbicide composition comprising at least one herbicide agent and a mixture for enhancing at least one activity of the herbicide agent, wherein said mixture comprises:

a) at least one type of organic acid,

b) at least one detergent

Surprisingly, it was found that herbicide compositions comprising a conventional herbicide agent and a mixture comprising organic acids and detergents exhibit significant higher activities than the substances alone or incomplete mixtures of them. Moreover, as said mixtures are highly biocompatible and the amount of herbicide agent in the composition can be significantly reduced, biocompatibility of the herbicide composition according to the invention is enhanced as well. Thus, one aspect of the invention is the use of a mixture comprising at least one type of organic acid, and at least one detergent for enhancing at least one activity of at least one herbicide agent.

Combining conventional herbicide agents with such mixtures enhances the general activity in a way that allows formulations with much lower concentrations of active ingredients from herbicide agents but that are still as effective as the much higher concentrations of the active ingredients in conventional formulations. Lower concentrations of active ingredients also have many other positive effects concerning for example biocompatibility, toxicity, technical applications and commercial aspects.

In particular, according to the invention highly efficient synergistic mixtures that, applied as an adjuvant or additive, are used to significantly increase the efficacy and biocompatibility of conventional herbicides for treatment of plants. The synergistic mixture thereby allows significant reduction of active ingredients of conventional herbicide products. The higher efficacy of the synergistic mixture also allows to address the elimination of herbicide-resistant or herbicide-tolerant plants.

Accordingly, the invention concerns new synergistic formulations to generate new herbicide products containing conventional herbicide agents for the treatment of all kind of weeds and unwanted plants as well as herbicide tolerant or resistant plants.

The herbicide agent is, for example, selected from the group consisting of glyphosate (N-(phosphonomethyl)glycine) and 2,4-dichlorophenoxyacetic acid (2,4-D) but any other herbicide such as 2-methyl-4-chlorophenoxyacetic acid (MCPA), methylchlorophenoxypropionic acid (MCPP), 3,6-dichloro-2-methoxybenzoic acid (Dicamba), N,N′-dimethyl-4,4′-bipyridinium dichloride (Paraquat), DL-phosphinothricin (Glufosinate), N-phenylphthalimide (Flumioxazin), cyclohexanedione (DIMS), 6-Chlor-N-ethyl-N-isopropyl-1,3,5-triazin-2,4-diamin (Atrazine), and S-[(4-chlorophenyl) methyl]diethylcarbamothioate (Thiobencarb) may also be suitable.

Advantageously, it is sufficient that the herbicide agent is included in the herbicide composition according to the invention in concentrations that are about 50% to 80% lower in concentrations than in the conventional product. Depending on the specific conventional herbicide product the preferred lower concentrations of the active ingredients in ready-to-use solutions are in the range from 0.1% to 1% (weight), in particular 0.25% to 0.5%, in relation to the total weight of the composition. Accordingly, lower amounts of herbicide agents in the synergistic herbicide composition according to the invention are sufficient to still achieve a significant inhibitory effect of plant growth and elimination of weeds or unwanted plants.

The detergent may be included in final concentrations from 0.05% to 1% (weight), in particular 0.1% to 0.25% (weight), in relation to the total weight of the composition.

The detergent may be at least one compound selected from the group consisting of anionic, amphoteric or cationic tensides, and suitable mixtures thereof.

The inventively applied detergents (i.e. surface-active substances) may be anionic, amphoteric or cationic tensides or suitable mixtures thereof. Especially, alkylethersulfate, alkyl- and/or arylsulfonate, alkylsulfate, amphotensides, betaines, alkylamidoalkylamines, alkyl substituted amino acids, alkyl substituted imino acids, acylated amino acids, and amphotenside combinations can be used. In principle all tensides supporting a positive synergistic effect are suitable.

It is particularly advantageous if the detergent is selected from the group of anionic surfactants such as, for example, organosulfates or organosulfonates. “Anionic surfactants” as used herein refers to surface-active substances (detergents) comprising anionic functional groups, such as sulfates, sulfonates, phosphates or carboxylates, at their head. Anionic surfactants such as, for example, sodium dodecyl sulfate (SDS) or sodium olefine sulfonate (SOS), are well-suited to enhance the efficiency of herbicides within the composition according to the invention.

In one exemplary embodiment, the organic acid can be included in concentrations from 0.05% to 0.5% (weight), in particular 0.1% to 0.25% (weight), in relation to the total volume of the ready-to-use composition.

The organic acids that may be used in preparing herbicide compositions of the present invention are either solid or liquid in their natural state and are readily soluble or dissolved in or miscible with water or an aqueous based solvent. Exemplary acids include the organic acids, especially the carboxylic acids such as citric acid, valeric acid, itaconic acid, acetic, citriconic acid, lactic acid, malic acid, succinic acid, aldaric acid, malonic acid, proprionic acid, malonic acid, maleic acid, salicylic acid, glutaric acid, tartaric acids, benzoic acid and the like.

The efficacy and biocompatibility of the herbicide composition according to the invention can be most notably increased if the detergent and the organic acids are included at a ratio of approximately 1:1 (w/w).

For example, the herbicide composition according to the invention comprising at least one conventional herbicide, detergents (surface-active substances) and organic acids for effective herbicidal action according to the invention may include:

herbicide: 0.1%-1.0%

detergent: 0.1%-1.0%

organic acid: 0.1%-1.0%

In order to further enhance the activity of the herbicide according to the invention, the ratio of herbicide agent, organic acid and detergent can be adjusted to about 1:1:1.

The herbicide composition according to the invention may further comprise, for example, at least one additive, adjuvant, sticking or wetting agent and/or buffer substance, especially in order to render the composition suitable for specific applications.

Accordingly, the invention-related formulation may comprise additional common conventional additives and adjuvant like, for example, suitable sticking and wetting agents or buffer substances for defining a specific pH value.

If necessary, the pH value of the herbicide composition according to the invention can be adjusted to a pH between 2 and 5 by the addition of suitable acids or buffer systems.

The herbicide composition according to the invention is a ready-to-use formulation that can be used for all aspects of weed elimination.

The herbicide composition according to the invention can be provided, for example, as a 10×fold to 100×fold concentrate. For example, concentrated formulations of 10×fold to 100×fold may be used for production and shipment.

In general, herbicide application is achieved by spraying the composition according to the invention onto soil and/or plants, especially weeds. The applied methods are however variable and can be adjusted to the different tasks.

According to one aspect of the invention, a method for treatment of soil and/or a surface of a plant comprises the following steps: applying the herbicide composition according to the invention to the soil and/or the surface of said plant.

The object is also met by the use of a synergistic composition comprising at least type of organic acid and at least one detergent for enhancing at least one activity of at least one herbicide agent. According to the invention, a composition or mixture as described herein is provided, which significantly enhances at least one activity of at least one herbicide agent so that efficacy and biocompatible of a herbicide agent comprising said ingredients and said mixtures can be significantly increased.

According to one aspect of the invention, a method for producing a herbicide composition is provided, wherein a mixture is added to at least one herbicide agent, said mixture comprising at least one type of detergent and at least one organic acid.

In one embodiment of the aforementioned use or method, the herbicide agent can be selected, for example, from the group consisting of glyphosate and 2,4-dichlorophenoxyacetic acid (2,4-D), MCPA(2-methyl-4-chlorophenoxyacetic acid), MCPP (methylchlorophenoxypropionic acid), Dicamba (3,6-dichloro-2-methoxybenzoic acid), Paraquat (N,N′-dimethyl-4,4′-bipyridinium dichloride), Glufosinate (DL-phosphinothricin), Flumioxazin (N-phenylphthalimide), DIMS (Cyclohexanedione), Atrazine (6-Chlor-N-ethyl-N-isopropyl-1,3,5-triazin-2,4-diamin), and Thiobencarb (S-[(4-chlorophenyl) methyl]diethylcarbamothioate).

In the following, the invention is exemplarily illustrated in detail with reference to the trials and tables.

Description of Exemplary and Preferred Embodiments:

Brief Description of the Trials

The activity of the synergistic mixtures to enhance the efficacy of herbicides was tested in vitro by leaf disc bioassays, in growth chamber trials with seedlings and in field trials with various different weed species.

The plants and leaves were visually assessed for damages by necrosis and chlorosis with the following scale for evaluation:
0: no damage
+: minor damages
++: severe damages on up to 50% of leave surface
+++: damages on more than 50% of leave surface
++++: 100% damage

Leaf Disc Bioassay

5 mm discs were cut from leaves of plants from Plantiago major, Sesamum indicum, Aegopodium potagraria and Chelidonium majus using a paper punch (5 mm). 3 leaf discs of 5 mm Ø were placed in each well of 12-well microtiter plates. Each well containing 2 ml deionized H₂O, or solutions of various concentrations of glyphosate, 2,4-D or synergistic mixtures (M). The plates were incubated under continuous light at 20° C. for the listed times. The leaf discs were visually assessed for chlorosis and necrosis at various times after treatment according to the scale for classification. The visual rating utilized a rating scale from 0 to ++++, where 0=no damage by necrosis/chlorosis, and ++++=total damage by chlorosis/necrosis (see Literature [1]).

Growth Chamber Trials with Seedlings

Seeds from Sesamum indicum or Lepidum sativum were placed on sterile filter paper of 4×4 cm wetted by sterile water. After a preincubation of 3 to 5 days at 20° C. seedling plants of 2-3 cm height and with first green leaves were treated by one spray application using deionized H₂O (control) or solutions of various concentrations of glyphosate, 2,4-D or synergistic mixtures (M). The spray application was done until the leaves were dropping wet. The leaves of the seedlings were visually assessed for chlorosis and necrosis at various times after treatment according to the scale for classification. The visual rating utilized a rating scale from 0 to ++++, where 0=no damage by necrosis/chlorosis, and ++++=total damage by chlorosis/necrosis.

Field Trials

Field trials were done on defined plots of weed under mostly sunny conditions with 20° C. to 25° C. The plot size was each with 1 m×5 m=5 m² or 1 m×10 m=10 m². The stage of annual weed plants was of 40-50 cm height. All plots were on the same field and side by side. There was only one spray application by knapsack sprayer. The documentation of trial plots was about every 7 days. The major weed species in the plots were mixtures of Avena sterilis, Brachystachys, Malva spec., Phalaris, Raphanus equistiforme and Trifolium micranthum. The weed plants were visually assessed for chlorosis and necrosis at various times after treatment according to the scale for classification. The visual rating utilized a rating scale from 0 to ++++, where 0=no damage by necrosis/chlorosis, and ++++=total damage by chlorosis/necrosis.

Brief Description of the Tables

Table 1 shows selected conventional herbicides tested for synergistic activities and their abbreviations used in the figures and legends.

Table 2 shows selected mixtures (M1-M6) and concentrations of ingredients that applied as additives or adjuvant for herbicides in the different tests resulted in synergistic enhancement of the herbicide activities of the tested conventional herbicide agents glyphosate and 2,4-D.

Table 3 shows an example of the leaf disc bioassay with 5 mm discs cut from leaves of Sesamum indicum. 3 leaf discs of 5 mm Ø were placed in each well of 12-well microtiter plates. Each well containing 2 ml deionized H₂O, or solutions of various concentrations of glyphosate or synergistic mixture M2 with a 1:1 mixture of citric acid and SOS. The plates were incubated under continuous light at 20° C. for the listed times. The leaf discs were visually assessed for chlorosis and necrosis according to the scale for classification and listed for hours after treatment (HAT). The visual rating utilized a rating scale from 0 to ++++, where 0=no damage by necrosis/chlorosis, and ++++=total damage by chlorosis/necrosis.

Table 4 shows an example of the leaf disc bioassay with 5 mm discs cut from leaves of the common lawn weed Plantiago major. 3 leaf discs of 5 mm Ø were placed in each well of 12-well microtiter plates. Each well containing 2 ml deionized H₂O, or solutions of various concentrations of 2,4-D or synergistic mixture M4 with a 1:1 mixture of citric acid and SDS. The plates were incubated under continuous light at 20° C. for the listed times. The leaf discs were visually assessed for chlorosis and necrosis according to the scale for classification and listed for hours after treatment (HAT). The visual rating utilized a rating scale from 0 to ++++, where 0=no damage by necrosis/chlorosis, and ++++=total damage by chlorosis/necrosis.

Table 5 shows an example of growth chamber trials with seedlings from Sesamum indicum. Seeds placed on sterile filter paper of 4×4 cm were wetted by sterile water. After a preincubation of 3 to 5 days at 20° C. seedling plants of 2-3 cm height and with first green leaves were treated by one spray application using deionized H₂O (control) or solutions of various concentrations of glyphosate or synergistic mixtures M2 with a 1:1 combination of citric acid and SOS. The spray application was done until the leaves were dropping wet. The leaves of the seedlings were visually assessed for chlorosis and necrosis according to the scale for classification and listed for days after treatment (DAT). The visual rating utilized a rating scale from 0 to ++++, where 0=no damage by necrosis/chlorosis, and ++++=total damage by chlorosis/necrosis.

Table 6 shows an example of field trials on defined plots of weed under mostly sunny conditions with 20° C. to 25° C. The plot size was each with 1 m×10 m=10 m². The stage of annual weed plants was of 40-50 cm height. All plots were on the same field and side by side. There was only one spray application by knapsack sprayer with various concentrations of glyphosate or synergistic mixture M2 with a 1:1 mixture of citric acid and SOS. The documentation of trial plots was about every 7 days after treatment (DAT) as listed. The major weed species in the plots were mixtures of Avena sterilis, Brachystachys, Malva spec., Phalaris, Raphanus equistiforme and Trifolium micranthum. The weed plants were visually assessed for chlorosis and necrosis according to the scale for classification. The visual rating utilized a rating scale from 0 to ++++, where 0=no damage by necrosis/chlorosis, and ++++=total damage by chlorosis/necrosis.

Table 7 shows an example of field trials on defined plots of weed under mostly sunny conditions with 20° C. to 25° C. The plot size was each with 1 m×5 m=5 m². The stage of annual weed plants was of 40-50 cm height. All plots were on the same field and side by side. There was only one spray application by knapsack sprayer with various concentrations of glyphosate or synergistic mixture M2 with a 1:1 mixture of citric acid and SOS. The documentation of trial plots was about every 7 days after treatment (DAT) as listed. The major weed species in the plots were mixtures of Avena sterilis, Brachystachys, Malva spec., Phalaris, Raphanus equistiforme and Trifolium micranthum. The weed plants were visually assessed for chlorosis and necrosis according to the scale for classification. The visual rating utilized a rating scale from 0 to ++++, where 0=no damage by necrosis/chlorosis, and ++++=total damage by chlorosis/necrosis.

TABLE 1
Selected conventional herbicides tested for synergistic activities
and their abbreviations used in the figures and legends.

| | |
|---|---|
| GLY | glyphosate (formulated product |
| | ROUNDUP. Monsanto, with 486 g/l |
| | isopropylamine salt of glyphosate) |
| 2,4-D | 2,4-dichlorophenoxyacetic acid |
| | (97% pure chemical grade |
| | substance from Sigma-Aldrich) |

TABLE 2

| Mixtures: | M1 | M2 | M3 | M4 | M5 | M6 |
|---|---|---|---|---|---|---|
| Substances: | | | | | | |
| (tested with 0.1%-1.0% | | | | | | |
| in ready-to-use formulation) | | | | | | |
| citric acid | | + | | + | | |
| lactic acid | + | | | | + | |
| tartaric acid | | | + | | | + |
| Betaine(Undecylamidopropylbetaine) | + | | | | | |
| Maranil(Alcylbenzolsulfonate) | | | + | | | |
| SDS(Sodium-Lauryl-Sulfate) | | | | + | | |
| SEHS(Sodium-2-EthylHexyl-Sulfate) | | | | | + | |
| SOS(Sodium-Olefine-Sulfonate) | | + | | | | |
| Tween 20(Polyoxyethylenesorbitane- | | | | | | + |
| monolaurate) | | | | | | |

TABLE 3

| | application | necrosis and | necrosis and |
|---|---|---|---|
| | rate in % of | chlorosis | chlorosis |
| substance | volume | 33 HAT | 66 HAT |
| control | − | 0 | 0 |
| GLY | 0.5 | 0 | + |
| GLY | 0.25 | 0 | 0 |
| GLY | 0.1 | 0 | 0 |
| GLY + M2 | 0.5 + 0.5 | ++ | ++++ |
| GLY + M2 | 0.25 + 0.25 | ++ | ++++ |
| GLY + M2 | 0.1 + 0.1 | + | +++ |

TABLE 4

| | application | necrosis and | necrosis and |
|---|---|---|---|
| | rate in % of | chlorosis | chlorosis |
| substance | volume | 18 HAT | 36 HAT |
| control | − | 0 | 0 |
| 2,4-D | 0.5 | 0 | 0 |
| 2,4-D | 0.25 | 0 | 0 |
| 2,4-D | 0.1 | 0 | 0 |
| 2,4-D + M4 | 0.5 + 0.5 | ++ | ++++ |
| 2,4-D + M4 | 0.25 + 0.25 | ++ | ++++ |
| 2,4-D + M4 | 0.1 + 0.1 | + | ++ |

TABLE 5

| | application | necrosis and | necrosis and |
|---|---|---|---|
| | rate in % of | chlorosis | chlorosis |
| substance | volume | 8 DAT | 16 DAT |
| control | − | 0 | 0 |
| GLY | 1.0 | 0 | + |
| M2 | 0.5 | 0 | 0 |
| GLY + M2 | 1.0 + 0.5 | ++ | ++++ |

TABLE 6

| | application | | necrosis and | necrosis and | necrosis and | necrosis and |
|---|---|---|---|---|---|---|
| | rate in % of | spray volume | chlorosis | chlorosis | chlorosis | chlorosis |
| substance | spray volume | per ha | 8 DAT | 14 DAT | 21 DAT | 30 DAT |
| control | − | − | 0 | 0 | 0 | 0 |
| M2 | 0.5 | 475 | 0 | 0 | 0 | 0 |
| GLY | 0.25 | 475 | 0 | 0 | 0 | 0 |
| GLY + M2 | 0.25 + 0.5 | 475 | ++ | ++++ | ++++ | ++++ |
| GLY | 0.5 | 475 | + | ++ | +++ | ++++ |
| GLY + M2 | 0.25 + 0.5 | 475 | ++ | ++++ | ++++ | ++++ |
| GLY | 1.0 | 475 | ++ | ++++ | ++++ | ++++ |
| GLY + M2 | 1.0 + 0.5 | 475 | ++ | ++++ | ++++ | ++++ |

TABLE 7

| | application | | necrosis and | necrosis and | necrosis and | necrosis and |
|---|---|---|---|---|---|---|
| | rate in % of | spray volume | chlorosis | chlorosis | chlorosis | chlorosis |
| Substance | spray volume | per ha | 7 DAT | 15 DAT | 21 DAT | 28 DAT |
| control | − | − | 0 | 0 | 0 | 0 |
| M2 | 0.25 | 480 | 0 | 0 | 0 | 0 |
| M2 | 0.5 | 480 | 0 | 0 | 0 | 0 |
| GLY | 0.25 | 480 | 0 | 0 | 0 | 0 |
| GLY + M2 | 0.25 + 0.25 | 480 | ++ | +++ | ++++ | ++++ |
| GLY + M2 | 0.25 + 0.5 | 480 | ++ | +++ | ++++ | ++++ |
| GLY | 0.5 | 480 | + | ++ | +++ | +++ |

### EXAMPLES

Table 2 shows selected mixtures (M1-M6) and concentrations of ingredients that applied as additives or adjuvant for herbicides in the different tests resulted in synergistic enhancement of the herbicide activities of the tested conventional herbicide agents glyphosate and 2,4-D. The preferred ratio of organic acid and detergent was 1:1 (w/w) and the preferred concentration with a general good enhancement of herbicide activity was 0.1% to 0.25%. At a concentration of 0.1% to 0.25% glyphosate or 2,4-D alone did not show any significant damage of plant leaves.

Table 3 shows an example of the leaf disc bioassay with 5 mm discs cut from leaves of Sesamum indicum. Glyphosate alone or the mixture M2 alone do not show efficient damage of the leaf discs under these conditions. A clear synergistic effect is observed for the combination of glyphosate and the mixture M2 with a faster action of the herbicide at also lower concentrations up to 0.1%.

Table 4 shows an example of the leaf disc bioassay with 5 mm discs cut from leaves of the common lawn weed Plantiago major. 2,4-D alone or the mixture M4 alone do not show efficient damage of the leaf discs under these conditions. A clear synergistic effect is observed for the combination of 2,4-D and the mixture M4 with a faster action of the herbicide at also lower concentrations of up to 0.1%.

Table 5 shows an example of growth chamber trials with seedlings from Sesamum indicum. Glyphosate alone or the mixture M2 alone do not show efficient damage of the seedlings under these conditions. A clear synergistic effect is observed for the combination of glyphosate and the mixture M2 with a faster action of the herbicide.

Table 6 shows an example of field trials on defined plots. Glyphosate at 0.25% or the synergistic mixture M2 with a 1:1 mixture of citric acid and SOS alone do not show efficient elimination of weed plants. A combination of 0.25% glyphosate with 0.5% of mixture M2 results in a clear synergistic effect by faster elimination of all major weed species in the plots like Avena sterilis, Brachystachys, Malva spec., Phalaris, Raphanus equistiforme and Trifolium micranthum.

Table 7 shows an example of field trials on defined plots. Glyphosate at 0.25% or the synergistic mixture M2 with a 1:1 mixture of citric acid and SOS alone do not show efficient elimination of weed plants. A combination of 0.25% glyphosate with 0.25% of mixture M2 results in a clear synergistic effect by faster elimination of all major weed species in the plots like Avena sterilis, Brachystachys, Malva spec., Phalaris, Raphanus equistiforme and Trifolium micranthum.

### REFERENCES

[1] V. K. Nandula, K. N. Reddy, S. O. Duke, D. H. Poston (2005) Glyphosate-Resistant Weeds: Current Status and Future Outlook. Outlook on Pest Management, 183-187.
[2] N. D. Teaster, R. E. Hoagland (2013) Varying Tolerance to Glyphosate in a Population of Palmer Amaranth with Low EPSPS Gene Copy Number. American Journal of Plant Sciences, Vol. 4, 2400-2408.
http://dx.doi.org/10.4236/ajps.2013.412297
[3] A. Samsel, S. Seneff (2013) Glyphosate, pathways to modern diseases II: Celiac sprue and gluten intolerance. Interdiscip Toxicol. Vol. 6(4): 159-184.
[4] R. E. Hoagland, R. H. Jordan and N. D. Teaster (2013) Bioassay and Characterization of Several Palmer Amaranth (Amaranthus palmeri) Biotypes with Varying Tolerances to Glyphosate. American Journal of Plant Sciences, Vol. 4, No. 5, 1029-1037.
http://dx.doi.org/10.4236/ajps.2013.45127

1. Herbicide composition comprising:
at least one herbicide agent, and
a mixture comprising:
a) at least one type of organic acid,
b) at least one type of detergent, wherein the mixture enhances at least one activity of the herbicide agent.

2. The herbicide composition according to claim 1, wherein the herbicide agent is selected from the group consisting of N-(phosphonomethyl) glycine, 2, 4-dichlorophenoxyacetic acid, 2-methyl-4-chlorophenoxyacetic acid, methylchlorophenoxypropionic acid, 3, 6-dichloro-2-methoxybenzoic acid, N, N′-dimethyl-4, 4′-bipyridinium dichloride, DL-phosphinothricin, N-phenylphthalimide, cyclohexanedione, 6-Chlor-N-ethyl-N-isopropyl-1, 3, 5-triazin-2, 4-diamin, and S-[(4-chlorophenyl) methyl] diethylcarbamothioate.

3. The herbicide composition according to claim 1, wherein the concentration of the herbicide agent is in the range from 0.1% to 1% (weight) in relation to the total weight of the composition.

4. The herbicide composition according to claim 1, wherein the detergent is included in concentrations from 0.05% to 1% (weight) in relation to the total weight of the composition.

5. The herbicide composition according to claim 1, wherein the detergent is at least one compound selected from the group consisting of anionic, amphoteric tensides, cationic tensides and suitable mixtures thereof.

6. The herbicide composition according to claim 1, wherein the organic acid is included in concentrations from 0.05% to 1% (weight) in relation to the total volume of the composition.

7. The herbicide composition according to claim 1, wherein the organic acid is a carboxylic acid.

8. The herbicide composition according to claim 7, wherein the organic acid is selected from the group consisting of citric acid, valeric acid, itaconic acid, acetic add, citriconic acid, lactic acid, malic acid, succinic acid, aldaric acid, malonic acid, proprionic acid, maleic acid, salicylic acid, glutaric acid, tartaric acids, and benzoic acid.

9. The herbicide composition according to claim 1, wherein the detergent and the organic acid are included at a ratio of approximately 1:1 (w/w).

10. The herbicide composition according to claim 1, wherein the herbicide agent, the organic acid and the detergent are included at a ratio of approximately 1:1:1 (w/w/w).

11. Herbicide composition according to claim 1, further comprising at least one additive, adjuvant, sticking or wetting agent and/or buffer substance.

12. Method for treatment of soil and/or a surface of a plant, comprising:
a) applying the herbicide composition according to claim 1 to the soil and/or the surface of said plant.

13. Method for enhancing at least one activity of at least one herbicide agent comprising:
providing at least one type of organic acid,
at least one detergent,
the at least one herbicide agent,
wherein the at least one type of organic acid and the at least one detergent enhances the at least one activity of the at least one herbicide agent when combined.

14. Method for producing a herbicide composition, comprising adding a mixture to at least one herbicide agent, wherein said mixture comprises at least one detergent and at least one organic acid.

15. Method according to claim 13, wherein the herbicide agent is selected from the group consisting of N-(phosphonomethyl)glycine, 2,4-dichlorophenoxyacetic acid, 2-methyl-4-chlorophenoxyacetic acid, methylchlorophenoxypropionic acid, 3, 6-dichloro-2-methoxybenzoic acid, N, N′-dimethyl-4, 4′-bipyridinium dichloride, DL-phosphinothricin, N-phenylphthalimide, cyclohexanedione, 6-Chlor-N-ethyl-N-isopropyl-1, 3, 5-triazin-2, 4-diamin, and S-[(4-chlorophenyl) methyl] diethylcarbamothioate.

16. The herbicide composition according to claim 3, wherein the concentration of the herbicide agent is in the range from 0.25% to 0.5% (weight) in relation to the total weight of the composition.

17. The herbicide composition according to claim 4, wherein the detergent is included in concentrations from 0.1% to 0.25% (weight), in relation to the total weight of the composition.

18. The herbicide composition according to claim 6, wherein the organic acid is included in concentrations from 0.1% to 0.25% (weight) in relation to the total volume of the composition.

19. The herbicide composition according to claim 2,
wherein the concentration of the herbicide agent is in the range from 0.1% to 1% (weight) in relation to the total weight of the composition,
the detergent is included in concentrations from 0.05% to 1% (weight) in relation to the total weight of the composition, and
the organic acid is included in concentrations from 0.05% to 1% (weight) in relation to the total volume of the composition.

20. The herbicide composition according to claim 19, wherein the detergent and the organic acid are included at a ratio of approximately 1:1 (w/w).
